(19) United States
(12) Patent Application Publication
(10) Pub. No.: US 2011/0005129 A1
(43) Pub. Date: Jan. 13, 2011

(54) GROUP OF FLOWERPOTS

(75) Inventor: Huibert Van Der Starre, Waddinxveen (NL)

Correspondence Address: EDWARDS ANGELL PALMER & DODGE LLP, P.O. BOX 55874, BOSTON, MA, 02205, US

(73) Assignee: BOOMKWEKERIJ VAN DER STARRE B.V., Boskoop (NL)

(21) Appl. No.: 12/817,828

(22) Filed: Jun. 17, 2010

(30) Foreign Application Priority Data
Jun. 17, 2009 (NL) 2003034

(51) Int. Cl. A01G 9/02

(52) U.S. Cl. 47/65.7; 47/86

(57) ABSTRACT

Group of flowerpots which can be grouped in a compact manner to form a rectangle, the outward appearance, on the other hand, conveying the impression of a larger size. This allows the space taken up to be optimized. In addition, the embodiment according to the invention provides a stable relationship between the various flowerpots of the group. This is achieved in that at least the upper edge of the group is formed, when viewed from above, in a polygonal and more particularly triangular or rectangular manner and one of the sides has a recess and the other, opposing side a protrusion corresponding thereto. When compactly grouped, the protrusion of one flowerpot falls into the recess of the other flowerpot, producing a stable overall entity.

### FIELD OF THE INVENTION

The present invention relates to a group of flowerpots which are arranged in a compact manner on a rectangle.

### BACKGROUND OF THE INVENTION

Flowerpots are transported with plants in groups and subsequently displayed. In counters of downwardly tapering flowerpots, the cross-sectional shape of the upper edge determines the number of flowerpots of this type which can be placed on a specific surface. That surface may be a transport surface such as the surface of a Euro container or of what is known as a Danish trolley. A Danish trolley can be used in nurseries and at auctions during the transportation of flowerpots to the place of sale. Further surfaces which are important are the shelf surface on which the flowerpots are offered to the consumer (end customer) for sale, the cultivation bed in which the plants are cultivated and display tables.

It is known in the art to form the upper surface of a flowerpot rectangularly. An example of this is found in European patent application 1208739 in the name of Huibert van der Starre.

A building block which is formed in the shape of a truncated pyramid is known from GB-A-2127872. By abutting one another in various ways, various sorts of walkways and rows of flower boxes can be obtained.

A hollow stone for producing vertical walls is known from DE 3406136. The outer circumference of this stone is formed in an undulating manner, this wave shape being such that bordering stones can be placed close together for forming a vertical wall.

### BRIEF SUMMARY OF THE INVENTION

The object of the present invention is to provide a group of flowerpots allowing the space taken up on a transport or other surface to be further optimized over European patent publication 1208739. In addition, it is the object of the present invention to make the apparent contents of the flowerpot in question appear as large as possible. A further object of the present invention is to further simplify the transportation of a group of flowerpots, allowing the number of measures for holding the flowerpots in place during transportation to be limited as much as possible.

A first aspect of the present invention provides a group of flowerpots, which are grouped in a compact manner to form a rectangle, each flowerpot comprising a bottom part, an adjoining wall part and an upper edge, the upper edge having a polygonal shape when viewed from above, one of said sides of the polygon being curved, which curvature defines a recess, and an opposing side of the flowerpot defining a protrusion and said flowerpots being arranged in said group in such a way that a protrusion of one flowerpot falls into the recess of another flowerpot in such a way that said flowerpots are fixed with respect to one another in said group by said protrusions and said recesses.

According to the present invention, the flowerpots are formed in a polygonal, such as triangular or rectangular, manner. One of the sides of the polygon is formed in a curved manner and thereby defines a recess. The opposing side defines a protrusion and the flowerpots are grouped in such a way that the recess of one flowerpot falls into the protrusion of the other flowerpot. As a result, the flowerpots in the group are fixed with respect to one another, thus preventing problems during transportation such as falling-over of the flowerpots. In addition, it has been found that this conveys to the user, in the case of a comparatively compact surface area or volume for each flowerpot, an appearance that suggests a larger surface area than the surface area or volume that is actually taken up or larger contents.

The group which is arranged on a transport face or display face consists of flowerpots which are fixed with respect to one another. That is to say, even when placed on a substantially horizontal bearing face, a stable overall entity is obtained, thus preventing individual flowerpots from falling over during transportation and sale.

According to a further aspect, the protrusion which falls into the recess can for example be defined by two bordering sides. This applies in particular to the variant in which the polygon is a triangle. Two sides of the triangle jointly form the protrusion, the third side being provided with the recess. It is however also possible for the protrusion to be formed by a curvature. According to a further aspect of the invention, the curvature of the protrusion and of the recess can be formed in a mirror image. More particularly, it is possible to provide one side with a wave-shaped curvature, said wave shape being a complete wave, that is to say a wave with a crest and a valley, the protruding part of the wave forming the protrusion and the setback part the recess. By forming a shape of this type in this way in the form of a mirror image on the bordering side of the following flowerpot or the opposing side of the flowerpot in question in the case of a rectangle as the polygon, a “double” interlocking of two bordering flowerpots can be obtained as a result of the fact that an interface contains two recesses and two protrusions which mutually engage. If, in the case of a rectangle, the sides positioned perpendicularly thereto are also formed in this way, a multiple mutual retention of the flowerpots in the group is produced, providing a particularly stable overall entity which is easy to handle. As described above, the appearance of a separate flowerpot from the group is such that the customer believes the volume to be greater than it actually is.

According to a further aspect of the present invention, the height of said wave is at least 10% of the distance of two opposing sides of the flowerpot.

According to a further aspect of the present invention, two bordering flowerpots can be fixed with respect to each other in the optimum interlocked position in just one way.

According to another aspect of the invention, the wave consists of a wave part, that is to say preferably merely a valley or a crest. It is also possible to arrange more than one wave, for example one and a half complete waves, on one side.

In the variant in which the polygon comprises a triangle, it is possible for the right side of one triangle, which forms the upper delimitation of one flowerpot, to rest against the other right side of another, bordering flowerpot.

According to a further aspect of the invention, the recesses and the associated protrusions are formed as stepped parts. Each part of the step can in turn comprise a wave shape. In this case, the wave can be formed in any desired manner such as sinusoidally. According to a further advantageous embodiment, the arrangement of the curvature on one side is symmetrical with respect to the centre of said side. As a result of the presence of for example two outwardly directed curvatures, which may for example be wave-shaped, a recess is delimited between said two wave parts.

It will be understood that the invention is not limited to flowerpots but can in principle be used for any sort of packaging. In addition, the flowerpot can comprise both an inner pot and an outer pot. The flowerpot is preferably made of a plastics material.

### BRIEF DESCRIPTION OF THE DRAWINGS

The invention will be explained hereinafter in greater detail based on a number of exemplary embodiments illustrated in the drawings, in which:

FIG. 1 is a schematic perspective view of a flowerpot according to a first embodiment according to the invention;

FIG. 2 is a plan view of a group of flowerpots according to FIG. 1;

FIG. 3 is a plan view of the flowerpot according to FIG. 1;

FIG. 4 is a plan view of a first variant of a group of flowerpots according to the invention;

FIG. 5 is a plan view of a second variant of a group of flowerpots according to the invention;

FIG. 6 shows a detail from the plan view according to FIG. 5;

FIG. 7 shows a further variant of the invention; and

FIG. 8 shows a fourth variant of the invention.

### DETAILED DESCRIPTION OF THE DRAWINGS

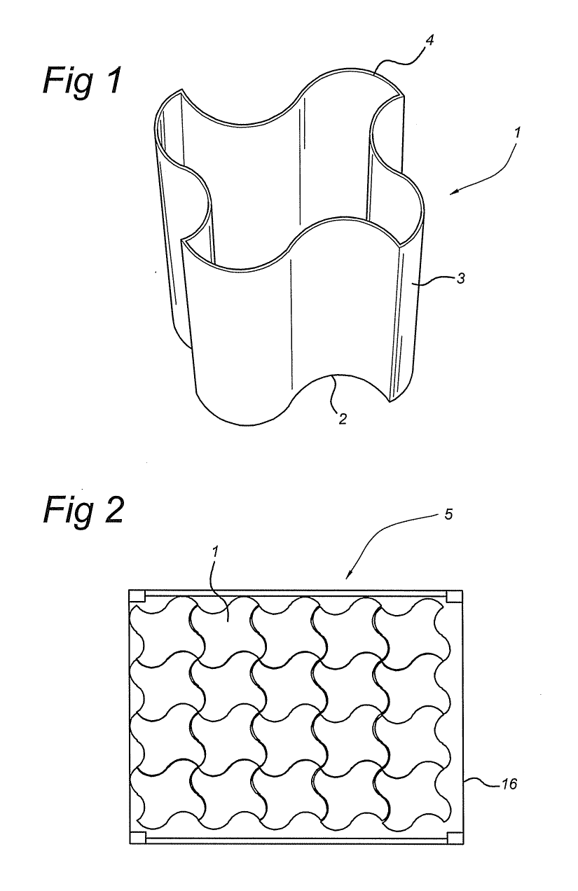

FIG. 1 shows a flowerpot denoted in its entirety by reference numeral 1. The flowerpot consists of a bottom part 2, a wall part 3 and an upper edge 4. According to the present invention, that part having the largest cross section, in this case the upper edge 4, is particularly important. When a group of flowerpots 1 are placed together, this upper edge will define the surface area which is taken up by a group of flowerpots. The bottom part and the wall part can be formed in any conceivable manner. Thus, it is possible to extend the wave shape shown in FIG. 1 of the upper edge into the wall and into the bottom 3. However, it is also possible to have the wave shape gradually run out in the wall, thus producing for example a round, ellipse-shaped, triangular or rectangular bottom 2. According to the present invention, all conceivable variants of the part under the upper edge 4 of the flowerpot are possible.

Plants which may be present in the flowerpot are not shown. This description will assume that the flowerpots are grouped in as compact a manner as possible during transportation and/or storage and/or placement on the shelf without possibly damaging plants contained in each flowerpot.

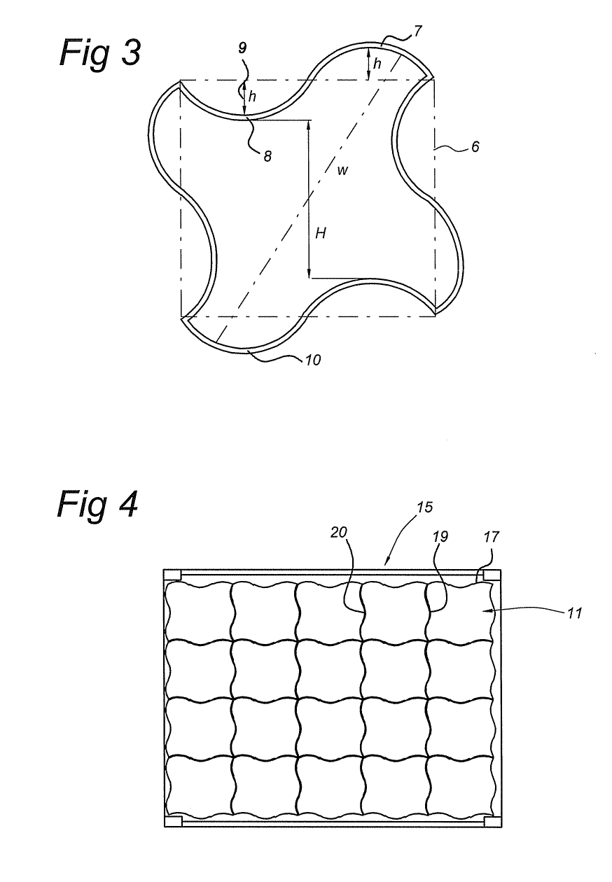

FIG. 2 shows a group of flowerpots 1 that is denoted in its entirety by reference numeral 5 in accordance with the present invention. For the sake of clarity, the plants contained therein are not shown. Reference numeral 16 denotes the rectangle within which the flowerpots are accommodated. In combination with FIGS. 1 and 3, it may be seen that each flowerpot 1, and more particularly the upper edge 4 thereof, consists of an imaginary square 6 around which a wave is arranged. The wave for each side consists of the wave parts 7 and 8, the wave part 8 defining a recess 9 and the wave part 7 a protrusion 10. The recesses 9 and protrusions 10 are arranged, as is clearly apparent from FIG. 2, in such a way as to allow interacting flowerpots 1 to be slid together in a compact manner, thus producing a stabler overall entity which is easy to handle and to transport. In this case, local space may be left between flowerpots placed one against another, for example for receiving a protrusion such as a carrier handle. When grouped together, each flowerpot appears larger than it actually is.

As a result of the mutual positioning in the manner shown in FIG. 2, the flowerpots are secured with respect to one another and falling-over can be prevented during transportation and/or when displayed at a sales outlet.

FIG. 3 is a plan view of the flowerpot used in the group from FIG. 2. The height of the “wave” is denoted by h while the distance between opposing sides is denoted by H.

According to the present invention, h is at least 10% of H. When the consumer looks at a flowerpot of this type, the effect of a comparatively deep and wide pot will be obtained in the direction of perception w, the actual volume of the pot being less as a result of the selected shape. That is to say, visually, the pot appears larger than the actual contents thereof. This means that a comparatively large number of pots can be placed together in a comparatively small space.

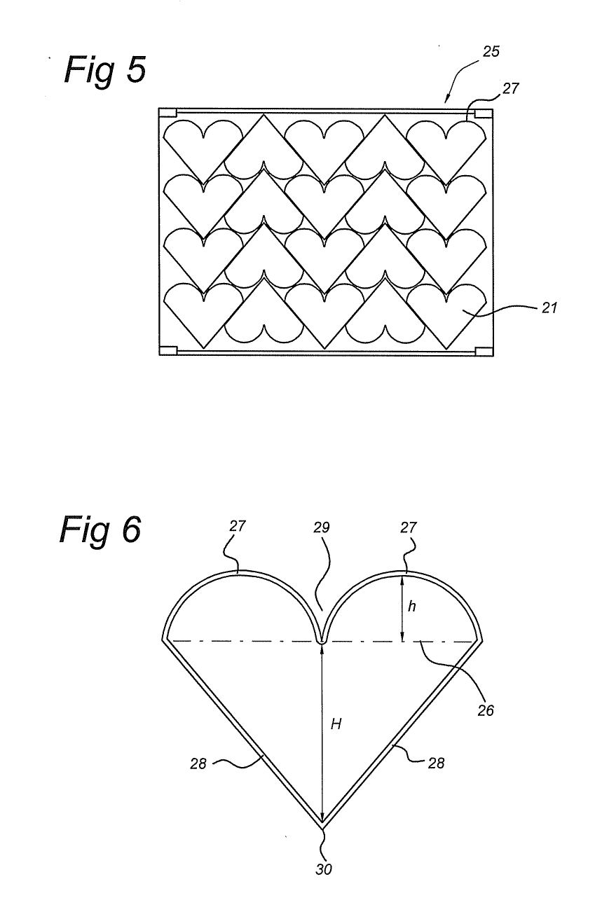

FIG. 4 is a plan view of a variant of the embodiment described hereinbefore of a flowerpot. The remaining particulars of the flowerpots with regard to the wall and the bottom are in principle the same as in the foregoing variant. It may be seen from FIG. 4 that the flowerpots 11 which are used there and are combined to form a group 15 are also shaped starting from an imaginary square, the wave arranged thereon comprising about one and a half complete waves. In this embodiment too, a particularly compact surface can be obtained by placing the flowerpots against one another. FIG. 5 illustrates a further variant of the invention. In this case, the flowerpots are in principle triangular, as may be seen from FIG. 6, and denoted in their entirety by reference numeral 21. Reference numeral 26 represents an imaginary line defining the triangular shape. Starting from this triangular shape, two wave parts 27, between which a recess 29 is delimited, are arranged on the side 26. The bordering sides 28 of the triangle define a protrusion 30. As may be seen from FIG. 5, the protrusion 30 falls into the recess 29 and produces in this manner a particularly stable overall entity. The indications h and H are also introduced in FIG. 6.

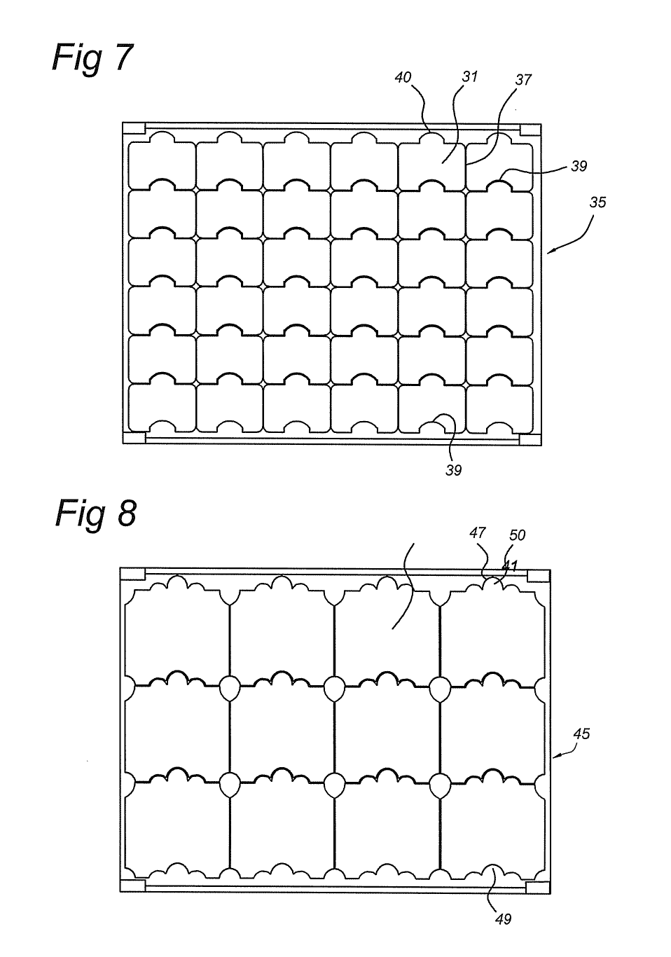

FIG. 7 illustrates a variant, the basic shape of the upper edge of the pot being substantially rectangular. In this case, a protrusion 40, which is formed as a wave part, protrudes from one side of the rectangle. A recess 39 is formed in the opposing side of the flowerpot. In this example, just two opposing sides of the wave shape or curvature according to the present invention are provided, while the other two opposing sides are not provided with a recess/protrusion of this type. It will be understood that it is also possible to arrange a shape of this type in the other sides. The same applies to the variant shown in FIG. 2, it being possible to form two opposing sides in a straight manner and the other two opposing sides in the shown manner of the wave shape.

A further exemplary embodiment is shown in FIG. 8, the curvature being formed in a stepped manner. The flowerpots are denoted by reference numeral 41 and combined to form a group 45. The protrusion consists of various protruding parts 50 which are in all cases constructed from a wave 47. The same applies to the recess 49. In this case too, the sides shown on the left and/or right can also be provided with any conceivable protrusions/recess shape, that is to say the shape as shown in FIG. 8 for the two opposing sides or one of the wave shapes shown previously.

On reading the foregoing description, the person skilled in the art will immediately think of a large number of variants which lie within the scope of protection of the appended claims.

1. Group of flowerpots, which are grouped in a compact manner to form a rectangle, wherein each flowerpot comprises a bottom part, an adjoining wall part and an upper edge, the upper edge having a polygonal shape when viewed from above, one of said sides of the polygon being curved, which curvature defines a recess, and an opposing side of the flowerpot defining a protrusion and said flowerpots being arranged in said group in such a way that a protrusion of one flowerpot falls into the recess of another flowerpot in such a way that said flowerpots are fixed with respect to one another in said group by said protrusions and said recesses.

2. Group according to claim 1, wherein that protrusion is defined by two bordering sides.

3. Group according to claim 1, wherein that protrusion comprises a curvature in said side.

4. Group according to claim 1, wherein said curvature comprises a wave shape.

5. Group according to claim 4, wherein said wave comprises a complete wave.

6. Group according to claim 4, wherein said wave comprises a wave part.

7. Group according to claim 4, wherein a wave part extends from the end delimitation of a side to the centre of a side.

8. Group according to claim 1, wherein said polygon comprises a triangle.

9. Group according to claim 8, wherein the side of one flowerpot that borders the side provided with the recess rests against the same side of a corresponding flowerpot.

10. Group according to claim 1, wherein said polygon comprises a rectangle.

11. Group according to claim 1, wherein said recess comprises a stepped part.

12. Group according to claim 1, wherein said flowerpots are made of plastics material.

13. Group according to claim 1, wherein said curvature has a deviation (h) with respect to the base line of the wall part in which this is shaped, which deviation h comprises at least 10% of the distance (H) from the wall part positioned opposite.

14. Group according to claim 1, arranged on a substantially horizontal bearing face.

15. Group according to claim 14, wherein that bearing face comprises a transport face or display face.
